(19) United States
(12) Patent Application Publication
(10) Pub. No.: US 2021/0138340 A1
(43) Pub. Date: May 13, 2021

(54) Interactive Entertainment Device

(71) Applicant: Simworx Ltd, Kingswinford, West Midlands (GB)

(72) Inventors: Terry Monkton, Kingswinford, West Midlands (GB); Matt Clarkson, Kingswinford, West Midlands (GB)

(21) Appl. No.: 16/623,668

(22) PCT Filed: Jun. 22, 2018
(86) PCT No.: PCT/GB2018/051745

§ 371 Date: Dec. 17, 2019

(30) Foreign Application Priority Data
Jun. 27, 2017 (GB) 1710253.4

(51) Int. Cl. A63F 13/285

(52) U.S. Cl. CPC A63F 13/285

(57) ABSTRACT

An entertainment system comprising a primary display, a plurality of seats, and a 4D effects system comprising one or more devices configured to provide a secondary sensory stimulation to users situated at the plurality of seats, wherein each of a plurality of seats has associated therewith a secondary display device and a user input device, wherein the secondary display device is configured to display different content to the primary display and the user input device is configured to accept one or more user inputs in response to the content displayed on the secondary display; wherein the 4D effects system selectively engages one or more of the devices to provide a secondary sensory stimulation to one or more of the plurality of seats based on the inputs received from the user input device associated with the one or more of the plurality of seats.

### TECHNICAL FIELD

The present disclosure relates to an interactive tablet for use in a 4D entertainment environment. Particularly, but not exclusively, the disclosure relates to tablet which enables an individual user in, for example, a theatre to interact with content shown on a primary screen to create a 4D experience. Aspects of the invention relate to a system and a method for enabling such interactions.

### BACKGROUND

So-called 4D entertainment is known in settings such as a cinema where users are presented with a primary screen on which content (for example a film) is shown. In addition to the primary screen further sensory stimulation is provided to the user, for example in the form of movement of the seats, lightning, smells, or air and water being blown onto the users/ members of the audience. Such secondary sensory stimulation is typically provided to the users to coincide with the content shown on the primary screen. For example a specific smell may be provided to coincide with the visual images.

As a result all users of the entertainment share the same common experience which is enhanced by the provision of the further sensory stimulation.

In such systems the users' sensory experience is predetermined and shared across all users. Thus whilst the users' experience an immersive experience the level of interaction with the content is limited.

### SUMMARY OF THE INVENTION

Aspects and embodiments of the invention provide an entertainment system claimed in the appended claims.

According to an aspect of the invention, there is provided an entertainment system comprising a primary display, a plurality of seats, and a 4D effects system comprising one or more devices configured to provide a secondary sensory stimulation to users situated at the plurality of seats, wherein each of a plurality of seats has associated therewith a secondary display device and a user input device, wherein the secondary display device is configured to display different content to the primary display and the user input device is configured to accept one or more user inputs in response to the content displayed on the secondary display; wherein the 4D effects system selectively engages one or more of the devices to provide a secondary sensory stimulation to one or more of the plurality of seats based on the inputs received from the user input device associated with the one or more of the plurality of seats.

The present invention therefore provides an enhanced system in which the user's experience and interaction is improved. In particular as the primary content is displayed there is a shared, collective, experience which is subsequently enhanced by the secondary tablet display. Furthermore as each user is able to interact with their own secondary display (for example where the secondary display is a touchscreen thus allowing direct user interaction or via a separate keypad device or the like) each user is able to experience a certain level of personalisation in their experience. Furthermore, as the 4D effects system is driven by the user inputs the level of personalisation is enhanced further resulting in an improved user experience. This is in contrast with existing systems where the 4D effects are experienced equally by all users.

There is also provided a method of providing a secondary sensory stimulation to users of an entertainment system comprising a primary display, a plurality of seats having secondary displays and user input devices, and a 4D effects system comprising one or more devices configured to provide the secondary stimulation, the method comprising the steps of: displaying primary on the primary display; for each of a plurality of seats displaying at the secondary display device different content to the primary display; accepting one or more user inputs in response to the content displayed on the secondary display at the user input device; and selectively engaging one or more of the devices of the 4D effects system to provide a secondary sensory stimulation to one or more of the plurality of seats based on the inputs received from the user input device associated with the one or more of the plurality of seats.

### BRIEF DESCRIPTION OF THE DRAWINGS

One or more embodiments of the invention will now be described, by way of example only, with reference to the accompanying drawings, in which:

FIG. 1 is a schematic of the apparatus in accordance with an embodiment of the invention;

FIG. 2 is a control block diagram of the apparatus; and

FIG. 3 is a flowchart of the method of an embodiment of the invention.

### DETAILED DESCRIPTION

FIG. 1 is a schematic of the apparatus in accordance with an embodiment of the invention.

There is shown the interactive system 10: comprising a primary display 12, and a 4D effects systems 14. The 4D effects system comprises a water unit 16, a misting unit 18, a smoke unit 20 an olfactory unit 22. As can be seen in FIG. 1 there may be multiple units of each type and for ease of reference only a limited number of each type of unit is displayed. The 4D effects system further comprises motion units 50, 52, 54, 56, 58, 60. The interactive system comprises a plurality of seats 26, 28, 30, 32, 34, 36. Each seat comprises an interactive tablet 38, 40, 42, 44, 46, 48 and a motion unit in the form of a motion effects seat 50, 52, 54, 56, 58, 60.

The interactive system 10 in an example is in the form of a ride at a theme park. The primary display 12 is a large projection screen which displays content to users. Such screens are known in the art. In further embodiments other forms of display are used. As is known in the art the primary display 12 is sized and positioned such that all users are able to view the content displayed. In an example the primary display 12 displays content such as a movie, a music video, a game etc.

The interactive system 10 further comprises a 4D effects systems 14. 4D effects systems 14 are known in the art and are commercially available. 4D effects systems 14 provide additional, secondary, sensory stimulation to the users of the system. As is known such sensory stimulation may include, but is not limited to, the spraying of water and/or mist via a water unit 16 and misting unit 18, providing smoke via a smoke unit 20 or smells via an olfactory unit 22. Furthermore the 4D effects system 14 may include a motion unit where the seat in which a user is sat is moved to provide the effect of motion to a user (see below).

The interactive system 10 comprises a plurality of seats 26, 28, 30, 32, 34, 36. For ease of understanding six seats are shown in FIG. 1 though the number of seats may be greater than or less than six.

In the system 10 some, preferably all, of the seats 26, 28, 30, 32, 34, 36 have a motion unit in the form of a motion effects seat 50, 52, 54, 56, 58, 60. The motion effects seat is configured to cause the respective seat to vibrate, or move, thus providing a user sat in the seat with the sensation of motion.

As is known in the art the 4D effects system 14 is configured to provide a secondary sensory effect at predetermined times, preferably to coincide with the content shown on the primary display 12 and, as described in detail below, and is further based on inputs from the interactive tablet.

In addition to the provision of the 4D effects system, for some, preferably all, of the seats there is provided a secondary display in the form of an interactive tablet 38, 40, 42, 44, 46, 48. Such tablets comprises a display which is also a touch screen. Thus the tablet is both a display and user input device as it allows for the user to input commands and gestures via the touch screen. The tablet in an embodiment is mounted onto its respective seat and positioned such that a user sat in the seat is able to view both the primary display 12 and their tablet.

In an embodiment the tablet is a known touch screen device, which is connected to a central controller (not shown) via a wired or wireless connection.

In use, primary content which is to be viewed by all users sat in the seats is displayed on the primary display 12. Additional, secondary, content, related to the primary content is simultaneously displayed on the interactive tablets 38, 40, 42, 44, 46, 48. The secondary content is different to the primary content, such that the tablet is not just a mirror of the primary display 12. Furthermore, the content displayed on the interactive tablets 38, 40, 42, 44, 46, 48 may also vary between tablets thus providing each user with a different experience.

Each user therefore interacts with the secondary content on their tablet by selection of content, swipe gestures etc. When a user makes an input on their tablet the input is sent to the central controller. As explained in further detail below if the individual user input on their tablet meets a predetermined criteria then in response to the input on the tablet a sensory effect from the 4D effects system 14 is initiated. The sensory effect may be localised to the individual users (for example movement may only occur on an individual chair) or it may affect all users (e.g. all the chairs are moved). Similarly an olfactory sensation may be directed towards a particular user, or group of users, in response to a user input. Therefore the present system 10 provides an improved immersive experience for a user where they are able to control, or at least influence, the 4D effects that they would experience. Furthermore as the sensory effect experienced by each user is in response to their input, the user's experience is personalised.

For example the primary display 12 may display a video and each interactive tablet 38, 40, 42, 44, 46, 48 displays a game related to the content. For example the tablet may show a quiz related to the displayed video. The user interacts with the tablet to select answers and in response to their answers a 4D effect is provided. For example if the user gets an answer incorrect they are sprayed with water from the water unit 16 and if the answer is correct smoke is generated form the smoke unit 20. Thus the individual user's experience will vary and be driven by their inputs. In further embodiments where multiple users are present, a first user's interaction with their tablet causes a secondary sensory effect for one or more different users. For example in the quiz embodiment the if a first user selects a correct answer before another user, the other, slower, user experiences a 4D effect, for example they are sprayed with water. Thus the 4D effects system 14 is driven by the inputs entered by the one or more users, thereby allowing the users' experiences to be varied based on the users' inputs and interactions with the interactive tablet 38, 40, 42, 44, 46, 48.

Accordingly by presenting the primary content on the main display 12 all users can share the same experience, as the main display 12 is visible to all users. Furthermore the use of the secondary display, on the interactive tablet, allows for each user to interact with content in a personalised manner which furthermore varies the 4D sensory experience. A further advantage is that the content on the secondary display may be varied to provide an improved user experience by providing thematic feedback with audiovisual and sensory feedback. By providing the personalised feedback the user is provided with overt and subliminal interactive engagement thus improving the user experience.

In further embodiments the interactive tablet for each seat is replaced by a head-up display (HUD) unit. The unit comprises a projection unit and a screen on which the images are rendered. Preferably the screen is positioned in the line of sight of the user when the user is looking at the primary display. HUD units allow for 3D images to be presented to the user thus further improving the user experience. In such embodiments the user is presented with a further user input device, for example a keypad to enable the user to interact with the content displayed on the HUD. In further embodiments the HUD comprises a touch screen which functions as the user input device.

FIG. 2 is a control block diagram of the apparatus shown in FIG. 1.

In FIG. 2 there is shown the primary display 102, and a number of users n1, n2, n3 and nx. The users in an embodiment are situated at fixed locations such as the seats as shown in FIG. 1 (the seats are not shown in FIG. 2). In further embodiments the users n1 to nx are able to freely move within an environment whilst carrying a display and user input device. In some embodiments the display is touch enabled display and therefore the display and user input device are the same device. In further embodiments the display and user input devices are separate devices.

The primary display 102 is controlled by a media controller 104. The media controller receives media from a media server 106. The media server 106 controls the content to be displayed on the primary display 102 as well as the content shown on the secondary devices (see below).

As is known in the entertainment industry timings and synchronisation are controlled using the SMPTE timecode. The use of SMPTE timecode enables audio and 4D effects to be synchronised with the media content as provided by the media server 106. A synchronisation codec 108 is used to control and synchronise content, preferably based on the SMPTE timecode.

The media controller 104 is further connected to a secondary effects controller 110. The secondary effects controller controls a 4D effects cue 112 (which defines what 4D effects are used and when and at what location) as well as the individual 4D effects and the secondary displays (for example the interactive tables) for users n1 to nx. As described with reference to FIG. 1 an aspect of the invention is that the individual users (n1 to nx) will experience different 4D effects based on the inputs received via the user input devices in response to the content shown on the secondary displays. The effect will vary between users and user n1 will experience 4D effects 114, n2 4D effects 116, n3 4D effects 118 and nx 4D effects 120. The secondary effects controller 110 is configured to control the 4D effects system to provide the 4D effects to each user n1 to nx.

The secondary effects controller 110 further controls the content shown on each of the secondary displays. Each user is associated with a secondary display with user n1 associated with secondary display 122, n2 display 124, n3 with display 126 and nx with display 128.

Depending on the nature of the content displayed on the secondary display each secondary display may show different content or the same content across all secondary displays (said content being different to the content shown on the primary display). The secondary displays are further controlled by the synchronisation codec 108 to ensure that the users' experience remains synchronised with any content shown on the primary display. For example if each secondary device displays a min-game related to the content on the primary display the game will only be displayed for a certain period of time and preferably all secondary devices will stop showing the secondary content at the same time. Thus whilst each user is able to experience a level of individuality and personalisation in their experience the synchronisation codec 108 ensures that content of the primary display 102 may be given priority over that of the secondary displays thus ensuring that the shared experience for all users takes priority over the secondary experience.

As such the invention provides the means for enabling users to experience a personalised 4D experience.

FIG. 3 is a flow chart of the process of the invention.

At step S102 content is displayed on the primary display. The user is typically unable to interact with the content on the primary display. A media controller will, based on the timecodes of the content, at predefined places in the content cause 4D sensory effects to occur to coincide with the primary content.

At step S104 content is displayed on the secondary display associated with the chairs of the users. The content is typically displayed concurrently to the content on the primary screen and is different to the content shown on the primary display. In other words the secondary display is not a mirror of the primary screen but rather shows its own content.

At step S106 interactive content is displayed on the secondary display. In some embodiments steps S104 and S106 occur concurrently, in that the content shown on at all times on the secondary display is interactive.

At step S108 the user interacts with the content shown on their secondary display. For example, the interactive content is a game and the user at step S108 plays the game by pressing on the user input device. In an embodiment the user input device is a touch screen and thus the display and the user input device are the same, or in alternative embodiments the user input device is separate from the display. For example the user input device is a keypad, a device with push buttons etc.

At step S110 the user's inputs are processed and sent to a central controller, the central controller being configured to control the 4D effects system.

At step S112 the central controller determines, based on the user inputs received at step S110, whether a 4D is required and if so the extent of the effect. The type of effect, and the extent and locale of the effect may be determined in accordance with the content displayed on wither the primary or secondary screen. In an embodiment the controller has a rules engine which determines what 4D is provided and at what stage.

At step S114 if an effect is required at step S112 the controller generates the appropriate signal to initiate the 4D effect for the given location.

Steps S108 to S114 loop until such time that the secondary display no longer displays any interactive content. Thus the user is able to experience multiple 4D effects which would have been generated from the inputs inputted at the user input device.

The present invention therefore provides the means for providing an enhanced user experience in which each user experiences a different experience based on their inputs and interaction with their secondary device.

1. An entertainment system comprising a primary display, a plurality of seats, and a 4D effects system comprising one or more devices configured to provide a secondary sensory stimulation to users situated at the plurality of seats, wherein
each of a plurality of seats has associated therewith a secondary display device and a user input device, wherein the secondary display device is configured to display content which is related to the content of the primary display and wherein the content displayed on the secondary display is different to the content displayed on the primary display, wherein the user input device is configured to accept one or more user inputs in response to the content displayed on the secondary display;
wherein the 4D effects system selectively engages one or more of the devices to provide a secondary sensory stimulation to one or more of the plurality of seats based on the inputs received from the user input device associated with the one or more of the plurality of seats.

2. The system of claim 1 wherein the secondary display device and user input device are the same device.

3. The system of claim 1 wherein the secondary device is a touchscreen tablet.

4. The system of claim 1 wherein the secondary device is a head up display unit.

5. The system of claim 1 wherein the 4D effects system comprises one or more of comprises a water unit, a misting unit, a smoke unit, an olfactory unit or a motion unit.

6. The system of claim 1 wherein the system further comprises a controller configured to synchronise the 4D effects system with one or more user inputs on the secondary devices.

7. The system of claim 6 wherein the controller is further configured to synchronise the 40 effects system with content displayed on the primary display.

8. The system of claim 7 wherein the synchronisation is based on a time code associated with the content displayed on the primary display.

9. The system of claim 8 wherein the time code is an SMPTE time code.

10. The system of claim 1 wherein the user inputs of a first user on their user input device cause a secondary sensory simulation effect to be direct to said first user.

11. The system of claim 1 wherein user inputs of a first user on their user input device cause a secondary sensory simulation effect to be direct to one or more different users.

12. The system of claim 1 wherein the secondary device displays one of a game, a video, or a quiz.

13. A method of providing a secondary sensory stimulation to users of an entertainment system comprising a primary display, a plurality of seats having secondary displays and user input devices, and a 40 effects system comprising one or more devices configured to provide the secondary stimulation, the method comprising the steps of:
displaying primary content on the primary display;
for each of a plurality of seats displaying at the secondary display secondary content, wherein the secondary content is related to the primary content of the primary display and wherein the secondary content is different to the primary content displayed on the primary display;
accepting one or more user inputs in response to the content displayed on the secondary display at the user input device; and
selectively engaging one or more of the devices of the 40 effects system to provide a secondary sensory stimulation to one or more of the plurality of seats based on the inputs received from the user input device associated with the one or more of the plurality of seats.

14. The method of claim 13 wherein the method further synchronising the 40 effects system with one or more user inputs on the secondary devices.

15. The method of claim 14 wherein the content displayed on the primary display is synchronised the 40 effects system.

16. The method of claim 15 wherein the step of synchronising is based on a time code associated with the content displayed on the primary display.

17. The method claim 13 wherein the user inputs of a first user on their user input device cause a secondary sensory simulation effect to be direct to said first user.

18. The method of claim 13 wherein user inputs of a first user on their user input device cause a secondary sensory simulation effect to be direct to one or more different users.
